(19) United States
(12) Patent Application Publication
(10) Pub. No.: US 2008/0183528 A1
(43) Pub. Date: Jul. 31, 2008

(54) INTELLIGENT EVENT ADAPTATION MECHANISM FOR BUSINESS PERFORMANCE MONITORING

(76) Inventors: Trieu C. Chieu, Scarsdale, NY (US); Shiwa S. Fu, Chappaqua, NY (US); Santhosh Kumaran, Peekskill, NY (US); Jih-Shyr Yih, Yorktown Heights, NY (US)

Correspondence Address: Whitham, Curtis, & Christofferson, P.C., Suite 340,, 11491 Sunset Hills Road, Reston, VA, 20190, US

(21) Appl. No.: 12/057,977

(22) Filed: Mar. 28, 2008

Related U.S. Application Data
(63) Continuation of application No. 11/337,562, filed on Jan. 24, 2006.

(51) Int. Cl. G06Q 10/00

(52) U.S. Cl. 705/7

(57) ABSTRACT

An intelligent business event adapter receives information technology (IT) events and raw data from a backend enterprise application to capture, analyze, transform, enrich, aggregate, and correlate application-dependent IT-level events into a business level event which is communicated to a business performance monitoring (BPM) server. The adapter comprises four modules: an Event Adaptation module, a business rules module, a data retriever module, and a data transformation module. The Event Adaptation module captures and analyzes IT events from the backend enterprise application. The business rules module stores business rules. The data retriever module is invoked by the Event Adaptation module to obtain business data according to business rules stored in the business rules module. The data transformation module forms business events to be forwarded to the BPM server.

### FIELD OF THE INVENTION

The present invention generally relates to enhancing adapter services to provide key performance indicators (KPIs) related events for business performance monitoring (BPM) and, more particularly, to a configurable business event adapter for capturing, analyzing, enriching, aggregating, correlating, and transforming application-dependent IT-level events into a business level event.

### BACKGROUND DESCRIPTION

Business performance monitoring (BPM) enables organizations to monitor and respond to changes in the business environment in order to optimize business performance relating to business goals. The business performance is measured by key performance indicators (KPIs) to reflect the outcomes of business activities in the underlying information technology (IT) layer. A KPI is usually defined from high-level business prospective and is calculated and extracted from information in the data sources of the underlying IT layer. Any transaction activity within the IT layer that potentially affects the resulting KPI must be adapted and propagated to the BPM system for further analysis.

To notify a BPM system of transaction activities in applications and data sources, dynamic IT-level event notification is often used. These events usually are application-dependent in format, arbitrary in degrees of completeness, and out-of-context, whereas a BPM system needs to obtain a complete, correlated set of event data in order to deduce the corresponding KPI.

Current application adapter technologies can capture these IT events and forward them to the target application with just a simple format conversion. As these simple adapters are not capable of analyzing, enriching, and adapting events and event related data, the BPM system has to perform filtering, sorting and correlation of these low-level events according to pre-defined business rules. There are several drawbacks associated with this simple approach. First, sending a large amount of unnecessary raw data to the target BPM system may undesirably overload the server. This is especially true when the size of the received data is large and unrelated to the calculation of the KPI. The situation gets worse when the target BPM system needs to interact with many applications and data sources to fulfill the KPI calculation. Second, sending bulky data from the backend system to the BPM system may consume network bandwidth which is undesirable. To seamlessly bridge the gap between KPIs and IT-level events, there is a need for a mechanism in the intermediate or middleware layer that can perform the tasks of adaptation and transformation.

### SUMMARY OF THE INVENTION

It is therefore and object of the present invention to provide a configurable business event adapter which provides event transformation based on business rules and KPI inputs and sends business related data to the BPM system.

According to the present invention, an intelligent event adaptation mechanism is provided for capturing and transforming application-dependent IT-level events into a standard event format. When receiving a request from the BPM server, the intelligent event adapter forms business messages to be forwarded to the BPM server in the following steps:

An Event Adaptation module extracts object key (e.g., sale order number) and KPI name from the request message and decides which actions to be taken to retrieve the target data using the object key.

The Event Adaptation module may activate several data handlers in the Data Retriever module to invoke application functions, based on the business rules, to retrieve the additional target data from backend data sources needed for the composition of business messages.

A Data Transformation module merges and converts all the retrieved data into standard business format and sends the business messages to the BPM system.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram showing a BPM system mediating real-time events from enterprise planning applications;

FIG. 2A is a block diagram showing a simple business event adaptation mechanism, and FIG. 2B is a block diagram showing a business event adaptation mechanism;

FIG. 3 is a block diagram showing a BPM server which interacts with multiple enterprise applications and data sources;

FIG. 4 is a block diagram illustrating components of the SAP business event adapter; and

FIG. 5 is a data flow diagram showing the flow in the Event Adaptation to fulfill one KPI (revenue).

### DETAILED DESCRIPTION OF A PREFERRED EMBODIMENT OF THE INVENTION

According to a preferred embodiment of the present invention, the intelligent event adaptation mechanism captures and transforms application-dependent IT-level events into a standard format called the Common Base Event (CBE). The CBE events are propagated to a Common Event Infrastructure (CEI) to be consumed by the BPM system. To facilitate the extraction of real-time information from a data source, the SAP system was chosen as an example for the source of transaction events. The SAP system is configured to generate workflow events using the SAP native conventions. The intelligent event adaptation functions are incorporated into the basic IBM WebSphere Business Integration (WBI) mySAP adapter to capture and filter SAP workflow events. In this preferred embodiment, the intelligent event adapter consists of four major modules: Event Adaptation module, Data Retriever module, Business Rules module, and Data Transformation module.

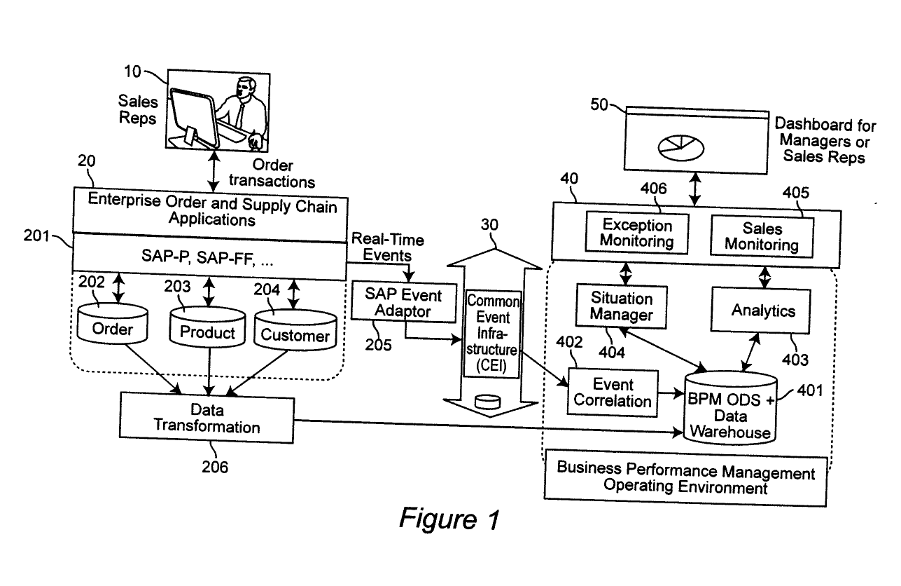

Referring now to the drawings, and more particularly to FIG. 1, there is shown a business call center in which sales representatives 10 typically use enterprise order and supply chain applications 20 to enter and process orders requested by customers. Real time events are sent to a common event infrastructure 30 to a business performance monitoring operating environment 40 which is accessed by managers or sales representatives using dashboard 50.

To view order status and sales performance, the sales representatives 10 usually request their performance reports through the IT department which performs database queries to the backend data sources. This report generation process typically requires manual steps, and thus imposes a long cycle time. The introduction of a BPM system with a web-based dashboard, such as shown in FIG. 1, provides an integrated and dynamic environment to allow sales representatives and managers to monitor and to react quickly to changing business situations. More particularly, in the preferred embodiment the enterprise order and supply chain applications interface with various SAP applications 201 which access an order database 202. a product database 203 and a customer database 204. The real time events are captured by an SAP event adaptor 205 which provides the interface between the SAP applications 201 and the common event infrastructure 30. In addition, the order database 202, the product database 203 and the customer database are accessed by data transformation module 206 which outputs data to the business performance monitoring operating environment 40.

The business performance monitoring operating environment 40 includes a BPM operating data store (ODS) and data warehouse 401 which receives data from the data transformation module 206 data from event correlation module 402. The event correlation module receives data from the common event infrastructure and performs a correlation function on the received data before that data is supplied to the data warehouse 401. The data warehouse is accessed by an analytics module 403 and a situation manager module 404. The output of the analytics module 403 is provided through a sales monitoring module 405 for display on a graphics user interface (GUI). The output of the situation manager module 404 is provided through an exception monitoring module 406 for display on the GUI.

In order to obtain real-time information, the BPM system deals with events emitted from different applications through custom event adapters and a CEI that handles events with standard format. The BPM system GUI (referred to herein as a dashboard) displays information for business activity monitoring, and an event capturing and processing infrastructure such as CEI and BPM operating environment 40 as shown in FIG. 1. The event processing system handles event-related operations. The BPM operating environment 40 monitors time-critical operational processes by correlating events from CEI and reports the state to the dashboard. The dashboard displays and alerts the state of business processes (in terms of KPI) to the end users.

To better illustrate the concept, a typical workflow scenario for a BPM system interfacing to SAP enterprise resource planning (ERP) applications using a SAP event adapter 30 is described in the following steps.

1. A sale representative conducts an order transaction (e.g., create an invoice) using the SAP application.
2. Real-time order transaction events are generated by SAP workflow processes and transmitted externally through the SAP Gateway.
3. The SAP event adapter connecting to the SAP Gateway receives the event and initiates a process sequence to mediate the events.
4. Based on the event type, the process sequence retrieves the detailed data related to the events from SAP system via the SAP event adapter, transforms and converts the data into STANDARD format, and emits the resulting event to CEI to be consumed by the BPM system.

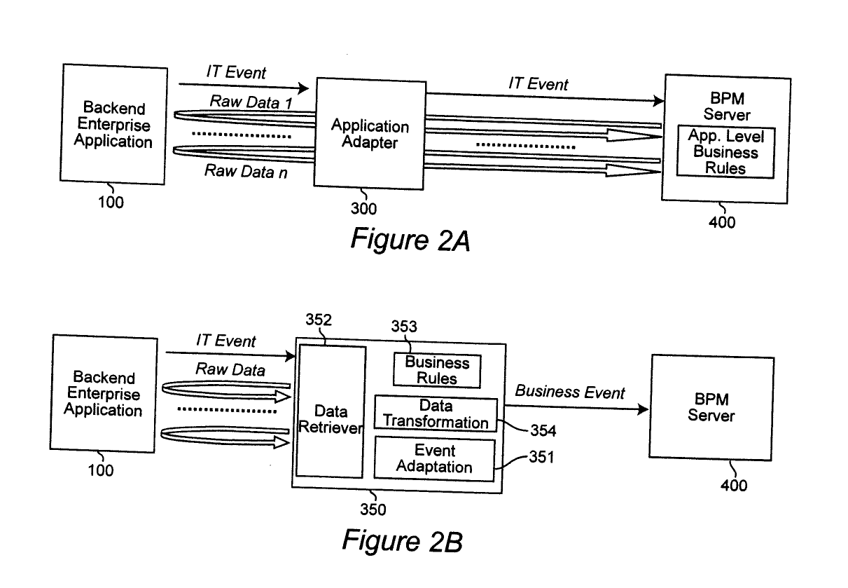

In a typical application adapter approach as shown in FIG. 2A, the adapter 300 captures IT events from the backend enterprise application 100 and forwards them to the target application with just a simple format conversion. The BPM system 400 has to perform filtering, sorting and correlation of these low-level events according to the pre-defined business rules. It also has to retrieve the corresponding target data multiple times via the adapter to form the KPI. Forwarding event and data in this manner poses the following drawbacks. First, sending large amount of unnecessary raw data to the target BPM system may undesirably overload the server. Especially, the size of the received data may be large and unrelated to the calculation of the KPI. In addition, sending bulky data from the backend enterprise resource process (ERP) system to the BPM system may consume network bandwidth, and is undesirable.

A better approach, as shown in FIG. 2B, alleviates the loading of BPM server by delegating the low-level event processing to an intelligent application event adapter 350 and emit business events relevant to KPI formation to the BPM server 400. Effectively, the low-level event processing workload is redistributed to the adapter so that the BPM server needs to handle business events emitted by the adapter. To achieve this, the event adapter needs to incorporate an event adaptation mechanism that captures, analyzes, enriches and transforms IT events and the corresponding business.

According to the present invention, there are four functional modules: to the intelligent application event adaptor 350: an Event Adaptation module 351, a Data Retriever module 352, a Business Rules module 353, and Data Transformation module 354. The Event Adaptation module 351 is responsible for capturing and analyzing the IT events and invoking the Data Retriever module 352 to obtain business data according to the Business Rules module 353. The Event Adaptation module 351 also uses the Data Transformation module 354 to form business events to be forwarded to the BPM server 400.

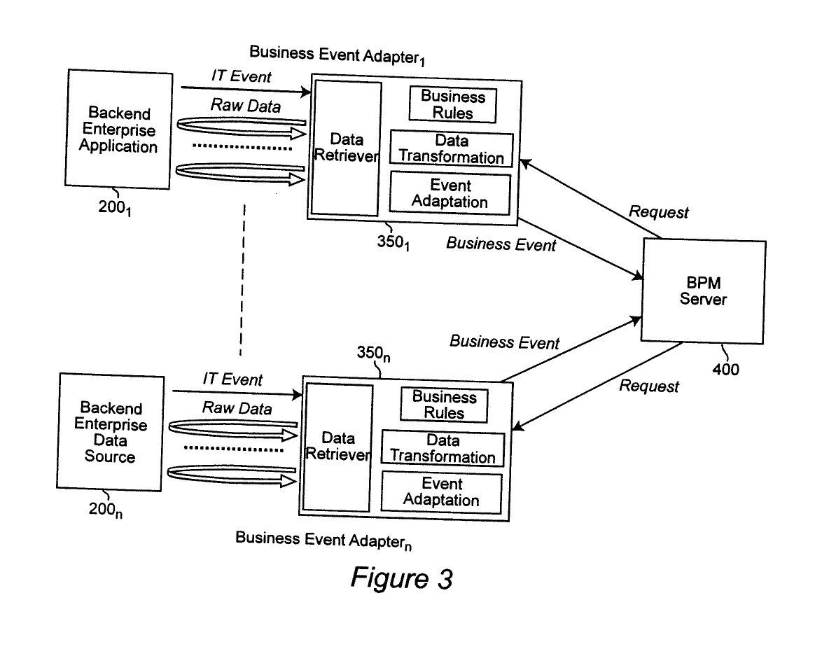

The calculation of a KPI may require information from different applications and data sources as depicted in FIG. 3. This illustrates a plurality of intelligent application event adaptors 350ₗ to 350ₙ each receiving IT events and raw data from respective backend applications 200ₗ to 200ₙ and communicating business events to the BPM server 400. In addition to preparing business level events in response to IT-level events, the event adapters also accept requests from the BPM server 400 to retrieve the required data based on the business rules and KPI inputs and returns business related messages to the BPM server.

In the preferred embodiment, an SAP backend system is used to provide real-time events, and an IBM WBI middleware adapter is used for event processing. SAP AG is a software company which produces software products in the business sector. International Business Machines Corp. (IBM) is a computer hardware and software company which provides business solution driven consulting, services and software for enterprises. Brief descriptions of these systems and their object model are given below.

In the SAP application software, a business object is used to encapsulate business data and functionalities and is the basic element for implementing business processes. The event generation is associated with the execution of internal workflow in business processes under business modules. SAP defines a wide range of business modules such as order entry, finance, human resources, material management, and etc. to fulfill a company's business process needs.

Each SAP business object's services (public methods) can be invoked by its interfaces, called Business Application Programming Interfaces (BAPIs). SAP's Business Object Repository (BOR) is the central access point for external applications. It stores all the SAP business objects and their corresponding BAPIs (methods) and provides the runtime environment for them. External applications usually use the SAP-specific protocol Remote Function Call (RFC) to enable the access to BAPIs in a synchronous mode. For asynchronous access, application may utilize the IDoc functional interface.

RFC with BAPI is a simple and efficient way to communicate with SAP applications for data retrieval, as it has minimal data transformation and no data overhead. IDoc is intended for dealing with large amount of data in a batch mode. The above interfaces are also utilized by a number of commercial SAP adapters to capture SAP events.

IBM WBI provides a number of adapters to interface with different enterprise applications. An adapter interacts with the target application, and translates business data between external formats and internal pre-defined business object formats using Data Handlers. It communicates with brokers such as IBM WebSphere InterChange Server (ICS), WBI Message Broker, and WebSphere Application Server (WAS) using a messaging mechanism or the Internet Inter-ORB Protocol (IIOP). Dedicated application adapters for SAP R/3, PeopleSoft, Simple Object Access Protocol (SOAP), IBM MQ Series, relational databases through JDBC, are just some examples. These application adapters can be easily modified and configured to fit new application requirements. For example, the mySAP adapter can easily be configured to communicate with SAP Gateway and invoke BAPI functions to retrieve business data.

The WBI adapter is based on an Object Discovery Agents (ODAs) mechanism to discover business object metadata for handling application specific business object. ODAs for several enterprise information applications are included in WBI tools, which can generate business object definitions automatically based on the application object meta-data. The business object definitions normally include application specific information that can instruct an adapter about the methods to interact with individual applications. In this embodiment, we leverage ODA tools to generate business object definitions to be used in our business event adaptation mechanism.

The description of the implementation of the SAP business event adapter according to the preferred embodiment of the present invention follows. First, the SAP configuration steps that are used to enable workflow events are described. Next, the core modules for the adapter are given.

To capture and transform IT-level events and the associated data into business-level events, the first step is to enable the SAP system to generate an event in response to an KPI-related order transaction executed either by the sale representative placing an order via mySAP GUI or by an SAP function call such as BAPI. In general, there are four approaches to enable events in the SAP system: code enhancement, change pointer, batch program, and business workflow. The code enhancement approach is not favorable by the SAP production system as code modification usually incurs subsequent maintenance efforts and support discontinuation concern. Similarly, the change pointer approach needs SAP code modification to turn on the change document flag. As the batch program approach does not provide synchronous event detection, it can not fulfill the real-time requirements for the BPM system. On the other hand, the business workflow approach is a flexible configuration mechanism that can be readily accessible by end users.

In the preferred embodiment, the business workflow approach is chosen to enable SAP event emission due to its advantages in easy implementation and maintenance, its synchronous nature to preserve real-time characteristics, and without modifying code in the SAP system. The following three configuration steps are needed to enable the SAP system to emit events to a WBI mySAP adapter:

1. Use a SAP transaction (e.g., SM59) to configure a mySAP RFC server ID in the SAP Gateway.
2. Use a SAP transaction (e.g., SWLD) to create an SAP business workflow task (e.g. abc) enabled with event detection called triggering event in the task.
3. Use a SAP transaction (e.g., SWE2) to bind the triggering event (created in Step 2) with the RFC server ID (created in Step 1).

Each SAP workflow event contains four major attributes: OBJTYPE, EVENT, RECTYPE, and OBJKEY. OBJTYPE is the SAP business object type (e.g., BUS2037 for invoice), EVENT is the action or “verb” (such as CREATE, CHANGE) of the event, RECTYPE represents the workflow task (e.g., abc in Step 2 above) that generates SAP event, and OBJKEY is the transaction ID (for example, order #, invoice #) These event attributes are made available in each emitted events, and can be utilized by the event adapter for initiation of subsequent adaptation actions.

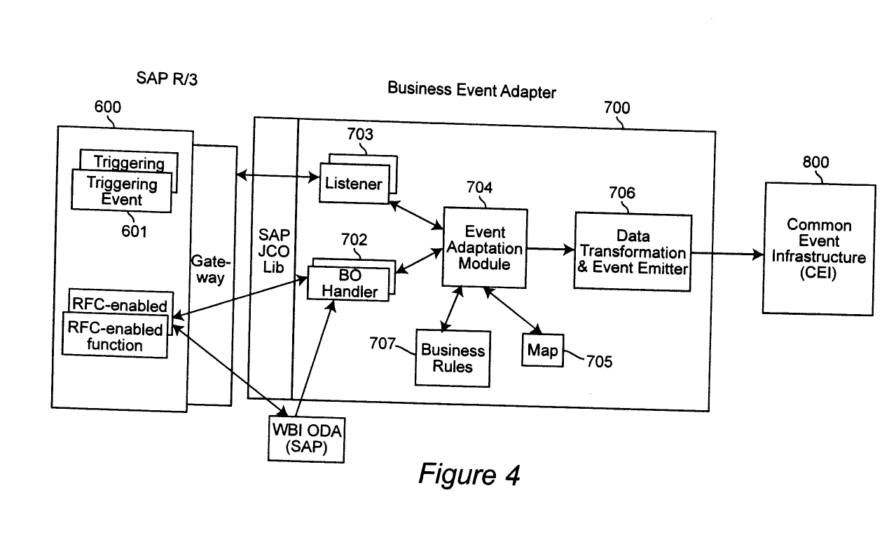

The core modules of business event adapter are illustrated in FIG. 4. As shown in FIG. 4, the business event adapter 700 is interposed between the SAP R/3 gateway 600 and the Common Event Infrastructure (CEI) 800. During the solution build-time, the WBI SAP Object Discovery Agents (ODA) tool is used to create business object definitions and a business object (BO) handler 702 for each SAP RFC-enabled function. The generated business object handler 702, part of the Data Retriever module, is a piece of Java executable code. During run time, the business object handler 702 retrieves data in flat format from the corresponding SAP function and converts the retrieved data into business object instances. The business object definitions normally include application specific information that can instruct the business object handlers about the methods to interact with individual SAP function.

The Listener 703 registers with the SAP Gateway 600 for event reception and polls the SAP Gateway to receive events 601. Once an event is detected, the event-related business object handler 702 converts the event into business objects and sends them to the Event Adaptation module 704. The business object produced by the business object handler 702 is called Application Specific Business Object (ASBO). If there is any conversion between an ASBO and a generic business object, a map 705 will be executed. The Data Transformation module 706 with an event emitter converts the final retrieved data in generic business objects into STANDARD format and sends them to the CEI 800. The Business Rules module 707 guides the Event Adaptation 704 to prepare business event accordingly.

Data retrieval is driven by business rules stored in the business rules module 707. After receiving an event, the Event Adaptation module 704 extracts OBJTYPE, EVENT, and OBJKEY (i.e., sale order number) from the event business objects. Based on the OBJTYPE and EVENT defined in the business rules, the Event Adaptation module 704 can decide which KPI is related to the received event and which action to be taken to retrieve the target data. The Event Adaptation module 704 could call several business object handlers to invoke SAP BAPI functions, based on the business rules, to fulfill each KPI.

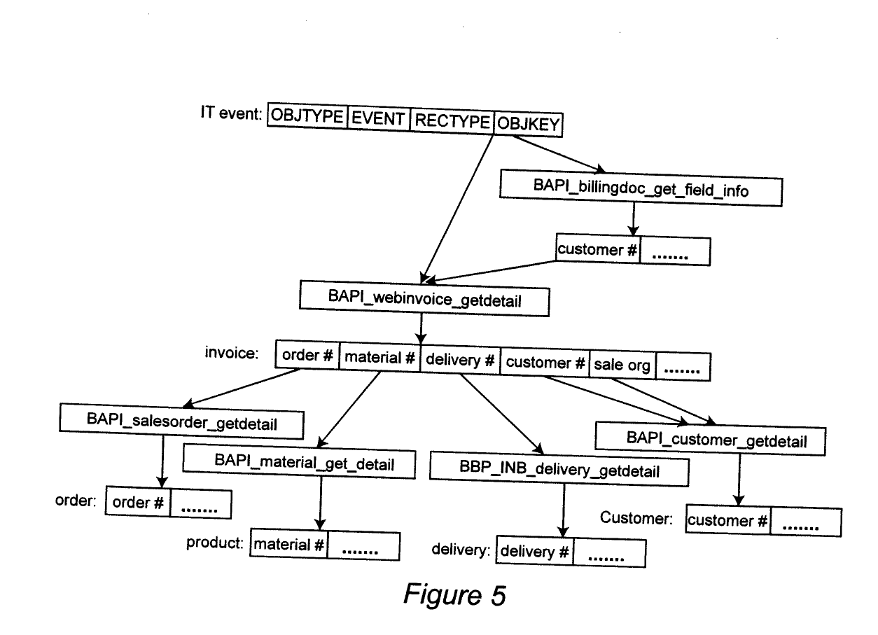

An example of the flow of the Event Adaptation to fulfill one KPI (Revenue in this case) is illustrated in FIG. 5. The Revenue KPI consists of five subcomponents: invoice, order, product (material in SAP's term), delivery, and customer. As the SAP event typically contains limited information for notification purpose, the Event Adaptation needs to call several SAP BAPI functions in sequence to get all desired data to fulfill the KPI. The received SAP event contains four major attributes: OBJTYPE, EVENT, RECTYPE, and OBJKEY. Based upon the OBJTYPE and the EVENT, the Event Adaptation can determine which related KPI needs to be fulfilled. The OBJKEY is the key to retrieve the target KPI related data. As shown in FIG. 5, by invoking SAP BAPI function Bapi_billingdoc_get_info, the Event Adaptation uses the invoice # in OBJKEY to retrieve the customer #. With the customer # and the invoice # as input parameters, the Event Adaptation retrieves detailed invoice information from BAPI_webinvoice_getdetail. Similarly, detailed order, product (material in SAP's term), delivery, and customer information are generated from the corresponding BAPI calls.

The adapter according to the invention performs event capture, transformation and mediation based on business rules and KPI inputs. By delegating IT-level event processing to the adapter, the system avoids sending bulk IT-level raw application data to the host BPM system, thus offloading the server's effort in processing non-essential IT-level raw information.

The invention has been described in terms of a single preferred embodiment. This embodiment utilizes various commercially available applications, but those skilled in the art will recognize that the invention can be practiced with modification, using other applications within the spirit and scope of the appended claims.

Having thus described our invention, what we claim as new and desire to secure by Letters Patent is as follows:

1. In a business performance monitoring (BPM) system in which business performance is measured by key performance indicators (KPIs) to reflect outcomes of an underlying information technology (IT) in a backend enterprise application, the improvement comprising an intelligent business event adapter receiving IT events and raw data from the backend enterprise application to capture, analyze, transform, enrich, aggregate, and correlate application-dependent IT-level events into a business level event which is communicated to a business performance monitoring (BPM) server.

2. The improvement in the BPM system recited in claim 1, wherein said intelligent business event adapter comprises:
an Event Adaptation module which captures and analyzes IT events from the backend enterprise application;
a business rules module storing business rules;
a data retriever module invoked by the Event Adaptation module to obtain business data according to business rules stored in the business rules module; and
a data transformation module to form business events to be forwarded to the BPM server.

3. The improvement in the BPM system recited in claim 2, wherein the data retriever module enriches business event information by retrieving additional information from data sources based on business rules stored n the business rules module to fill in missing information.

4. The improvement in the BPM system recited in claim 2, wherein the Event Adaptation module aggregates and combines related information to form complete business events.

5. The improvement in the BPM system recited in claim 2, wherein the Event Adaptation module correlates related temporal IT-level events to generate business events.

6. The improvement in the BPM system recited in claim 2, wherein the Event Adaptation module captures and processes real-time low-level events based on business rules and key performance indicator (KPI) inputs and forwards business related data to the BPM server.

7. The improvement in the BPM system recited in claim 2, wherein the adapter accepts requests from the BPM server to retrieve the required data based on business rules stored in the business rules module and key performance indicators (KPI) inputs from the backend enterprise application and forwards business data to the BPM server.

8. An intelligent business event method comprising the steps of:
retrieving information technology (IT) events and raw data from a backend enterprise application according to stored business rules;
capturing, analyzing, transforming, enriching, aggregating, and correlating application-dependent IT-level events into a business level event;
transforming business level events to be forwarded to a BPM server; and
communicating the transformed business level events to a business performance monitoring (BPM) server.

9. The intelligent business event method according to claim 8, wherein business event information is enriched by retrieving additional information from data sources based on the stored business rules.

10. The intelligent business event method according to claim 8, wherein related information is aggregated and combined to form complete business events.

11. The intelligent business event method according to claim 8, wherein related temporal IT-level events are correlated to generate business events.

12. The intelligent business event method according to claim 8, wherein real-time low-level events based on the stored business rules and key performance indicator (KPI) inputs are captured and business related data are forwarded to the BPM server.

13. The intelligent business event method according to claim 8, further comprising the steps of:
receiving a request from the BPM server to retrieve required data based on the stored business rules and key performance indicator (KPI) inputs for the backend enterprise application; and
forwarding business data to the BPM server in response to the request.

14. A computer readable medium storing code for controlling a computer to perform an intelligent business event method comprising the steps of:
retrieving information technology (IT) events and raw data from a backend enterprise application according to stored business rules;
capturing, analyzing, transforming, enriching, aggregating, and correlating application-dependent IT-level events into a business level event;
transforming business level events to be forwarded to a BPM server; and
communicating the transformed business level events to a business performance monitoring (BPM) server.

15. The computer readable medium according to claim 14, wherein the code controls the computer to enrich business event information is by retrieving additional information from data sources based on the stored business rules.

16. The computer readable medium according to claim 14, wherein the code controls the computer to aggregate and combine related information to form complete business events.

17. The computer readable medium according to claim 14, wherein the code controls the computer to correlate related temporal IT-level events to generate business events.

18. The computer readable medium according to claim 14, wherein the code controls the computer to capture and process real-time low-level events based on business rules and key performance indicator (KPI) inputs and forward business related data to the BPM server.

19. The computer readable medium according to claim 14, wherein the code controls the computer to perform the steps of:
receiving a request from the BPM server to retrieve required data based on the stored business rules and key performance indicator (KPI) inputs for the backend enterprise application; and
forwarding business data to the BPM server in response to the request.
